(19) United States
(12) Patent Application Publication
(10) Pub. No.: US 2026/0219403 A1
(43) Pub. Date: Jul. 30, 2026

(54) CAPILLARY MANGANESE HALIDE NEEDLE-LIKE ARRAY SCINTILLATOR WITH REFLECTIVE CLADDING AND METHOD

(71) Applicant: KING ABDULLAH UNIVERSITY OF SCIENCE AND TECHNOLOGY, Thuwal (SA)

(72) Inventors: Tengyue HE, Thuwal (SA); Omar F. MOHAMMED, Thuwal (SA); Yuanfan WEN, Thuwal (SA)

(21) Appl. No.: 19/463,762

(22) Filed: Jan. 29, 2026

Related U.S. Application Data
(60) Provisional application No. 63/751,047, filed on Jan. 29, 2025.

(51) Int. Cl. G01T 1/20

(52) U.S. Cl. CPC G01T 1/20183; G01T 1/2002

(57) ABSTRACT

A structured scintillator includes a capillary array template defining a plurality of pores, each having an inner wall. A reflective cladding is disposed on the inner wall of each pore to define a plurality of isolated waveguide channels. A metal halide scintillation material is disposed within the plurality of isolated waveguide channels. The reflective cladding is configured to confine photons generated by the metal halide scintillation material within the plurality of isolated waveguide channels to facilitate oriented light propagation toward an imaging plane. The structured scintillator is utilized in high-resolution X-ray imaging, where the reflective cladding minimizes lateral light crosstalk, allowing for increased scintillator thickness to improve X-ray absorption without compromising spatial resolution.

### CROSS-REFERENCE TO RELATED APPLICATIONS

This application claims priority to U.S. Provisional Patent Application No. 63/751,047, filed on January 29, 2025, entitled “MANGANESE HALIDE ARRAY SCINTILLATOR WITH ISOLATED LIGHT CROSSTALK FOR HIGH-RESOLUTION X-RAY IMAGING,” the disclosure of which is incorporated herein by reference in its entirety.

### BACKGROUND OF THE INVENTION

### TECHNICAL FIELD

Embodiments of the subject matter disclosed herein generally relate to the field of X-ray imaging and scintillation materials. More particularly, the disclosure relates to structured scintillators, such as needle-like array scintillators, and methods for fabricating the same using metal halide materials and reflective waveguide structures to minimize lateral light crosstalk.

### DISCUSSION OF THE BACKGROUND

Scintillator-based X-ray imaging detectors are utilized across various scientific and practical fields, including medical diagnostic imaging, industrial quality inspection of food and electronic devices, security monitoring, and geological surveys. One specific application involves the nondestructive testing of microelectronic components, where the diameter of bonding wires in electronic chips may fall below 30 μm. Discerning such fine structural features requires a scintillator with sufficiently high spatial resolution. Furthermore, electronic products often consist of intricate packaging, metal assemblies, and diverse silicon-based chips that demand higher energy X-rays to achieve adequate penetration for internal visualization. Consequently, a scintillator with a thickness on the order of several hundred micrometers or even millimeters may be used to ensure sufficient deposition of X-ray energy, thereby achieving a high signal-to-noise ratio (SNR). Generally, to balance X-ray imaging spatial resolution and scintillation brightness, it is desirable to maintain low lateral light crosstalk on a sufficiently thick scintillation screen.

However, a technical limitation exists in balancing the thickness of a scintillation screen with spatial resolution. As illustrated by the conventional scintillator 100 in FIG. 1A, typical non-structured scintillation screens rely on non-oriented emitters or bulk polycrystalline structures 102 distributed within a matrix material 104. In these arrangements, inherent grain boundaries and refractive index mismatches between the emitters 102 and the surrounding matrix 104 result in anisotropic propagation of generated scintillation photons 108, as shown in FIG. 1B. As these photons 108 travel through a standard screen, they undergo multiple scattering events that result in lateral light spread. This spread becomes progressively more severe as the thickness of the scintillator increases.

Statistical data of scintillator thickness versus X-ray imaging resolution from previous publications are shown in FIG. 2A. While reports of ultrahigh X-ray imaging resolution exceeding 100 lp mm⁻¹ often involve tens of micrometer-thin scintillators or specialized synchrotron radiation accelerator systems, thicker scintillators normally yield lower resolution. This light scattering results in off-track photons that create signal crosstalk at an imaging plane 110 (for example, a photo detector), reducing the SNR and causing the resulting image to appear blurred, as schematically illustrated in FIG. 1C.

Existing solutions for managing photon propagation, such as vertical vapor deposition of columnar structures or the use of anodic aluminum oxide (AAO) templates, involve significant technical constraints. For example, vertical vapor deposition growth of columnar CsI:Tl scintillators and melt filling into silica-coated silicon templates represent common pixelation schemes (1-3). However, such vapor deposition processes often require high temperatures, complex vacuum systems, and extended processing times, while silicon etching and oxidation processes involve high costs.

Other investigations have explored integrating high-refractive-index metal halide perovskite nanocrystals (MHPNCs) into a low-refractive-index AAO array template to achieve imaging resolution through total internal reflection. This strategy is limited by the thin thickness (typically below 50 μm) and low porosity of AAO, which restrict X-ray absorption and light output. Additionally, the physical fragility of AAO templates reduces the qualification rate during processing, and many MHPNCs exhibit stability issues, toxicity associated with lead, and significant self-absorption due to small Stokes shifts. Furthermore, selective orientation of 1D perovskite-like metal halide scintillators via close-space sublimation often lacks adequate reflective layers between columns, allowing for lateral photon leakage that limits the achievable spatial resolution in thicker screens.

Alternatively, a family of organic manganese halide (OMH) materials has been identified as a promising X-ray scintillation material due to high X-ray to visible light conversion efficiency, negligible self-absorption, and eco-friendly element composition (4-9). The low melting points of some OMH materials enable conversion from a crystalline state to a glassy state, providing low-temperature processing capabilities. However, such materials may exhibit insufficient X-ray absorption arising from a low linear attenuation coefficient, as shown in FIG. 2B.

This limitation is linked to the photoelectric effect, which serves as the dominant process in the interaction of X-rays with matter. This effect occurs primarily at the K-shell electrons, which possess the highest binding energy within the electron orbitals. X-ray absorption increases significantly at a specific energy threshold, known as the K-edge, which occurs when the incident X-ray energy exceeds the binding energy of these K-shell orbital electrons. Compared to all-inorganic or lead-based scintillators, the K-edge in OMH originates from relatively low-atomic number (low-Z) components. Consequently, OMH tends to exhibit sufficient X-ray absorption at lower energies, but the absorption power drops significantly at higher energies. Although doping or alloying higher Z elements into OMH can improve X-ray absorption, such optimizations are often limited and may negatively impact the optical properties or the low melting point advantages of the material.

Consequently, a need exists for a scintillator structure that provides both sufficient thickness for X-ray absorption and high spatial resolution by suppressing lateral light crosstalk. To address this, pixelated array scintillators may be developed to orient the propagation of scintillation photons along a vertical direction to weaken unwanted lateral photon leakage, or enable reflection of guided photons within a defined space (10-15). Such a structure could compensate for the deficiency in X-ray absorption by increasing the thickness of the material while maintaining a sufficiently high resolution.

In some aspects, even these pixelated array scintillators may face challenges, such as difficulties in achieving uniform material loading across high-aspect-ratio pores or potential mechanical instability in certain template materials and thus, there is a need for improved scintillator structures that can be manufactured reliably at scale while maintaining the technical advantages of pixelated waveguide architectures. In particular, a need exists for a configuration that ensures consistent performance across various thicknesses, effectively addressing the traditional trade-offs between X-ray absorption and image clarity.

### SUMMARY OF THE INVENTION

A structured scintillator includes a capillary array template that defines a plurality of pores. A reflective cladding is disposed on an inner wall of each pore to define a plurality of isolated waveguide channels, and a metal halide scintillation material is disposed within these isolated waveguide channels. The reflective cladding is configured to confine photons generated by the metal halide scintillation material within the plurality of isolated waveguide channels to facilitate oriented light propagation toward an imaging plane of a photodetector.

In some embodiments, the reflective cladding decouples a thickness of the metal halide scintillation material from a spatial resolution of an image produced at the imaging plane by preventing lateral light crosstalk between adjacent isolated waveguide channels. For example, the structured scintillator may have a thickness between 0.5 mm and 1.0 mm while achieving a spatial resolution at a modulation transfer function (MTF) of 0.2 that is numerically greater than a reciprocal of a diameter of the plurality of pores. The metal halide scintillation material may including an organic manganese halide, such as benzyl triphenylphosphonium manganese bromide (BTP₂MnBr₄). The reflective cladding may include an aluminum layer providing at least 90% reflectivity in a visible light range.

Fabrication of a structured scintillator may involve depositing a reflective cladding on inner walls of a plurality of pores defined by a capillary array template to form a plurality of isolated waveguide channels. A metal halide scintillation material is heated to a melt state and introduced into the plurality of isolated waveguide channels. The metal halide scintillation material is then cooled to form a pixelated needle-like array within the capillary array template. In certain embodiments, the capillary array template is preheated prior to introducing the metal halide scintillation material, and the temperature is maintained at approximately 200 °C for a duration sufficient to ensure the melt fills the plurality of isolated waveguide channels before reducing the temperature to room temperature.

### BRIEF DESCRIPTION OF THE DRAWINGS

For a more complete understanding of the present invention, reference is now made to the following descriptions taken in conjunction with the accompanying drawings, in which:

FIG. 1A is a schematic cross-sectional view of a conventional non-structured scintillator.

FIG. 1B is a schematic illustration of light propagation and scattering within a conventional non-structured scintillator.

FIG. 1C is a schematic illustration of imaging effects for the non-structured scintillator.

FIG. 2A is a scatter plot illustrating a relationship between scintillator thickness and spatial resolution.

FIG. 2B is a chart illustrating linear attenuation coefficients of various scintillation materials as a function of X-ray energy.

FIG. 3A is a schematic illustration of a structured scintillator system including a capillary array template.

FIG. 3B is a detailed schematic cross-sectional view of isolated waveguide channels within a capillary array template.

FIG. 3C is a schematic illustration of oriented light propagation and imaging results for a structured scintillator.

FIG. 4 is a flowchart illustrating a method for fabricating a structured scintillator.

FIG. 5 includes graphs illustrating photoelectric absorption coefficients and energy deposition efficiency as a function of X-ray photon energy.

FIG. 6 illustrates radioluminescence (RL) emission spectra for various scintillation materials.

FIG. 7 is a chart illustrating relative light output for various scintillation materials.

FIG. 8 is a graph illustrating RL intensity as a function of X-ray dose rate, including detection limits (DL).

FIG. 9 is a graph illustrating MTF curves for structured scintillators compared to a non-clad scintillator.

FIG. 10A is an X-ray image of a copper grid acquired using the scintillator of FIG. 3A.

FIG. 10B is an X-ray image of a storage card acquired using the scintillator of FIG. 3A.

FIG. 10C is an X-ray image of an integrated circuit package acquired using the scintillator of FIG. 3A.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a pixelated needle-like array scintillator using BTP₂MnBr₄ encapsulated in a reflective cladding including an aluminum layer. However, the embodiments to be discussed next are not limited to the combination of BTP₂MnBr₄ and aluminum layer, but may be applied to other types of organic manganese halides and/or reflective claddings.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Methods and devices described in this document embody techniques related to a pixelated needle-like array scintillator and methods for its fabrication. As used herein, a "structured scintillator" refers to a scintillation medium (or material) that is physically partitioned into a plurality of discrete optical channels or pixels, as opposed to a continuous or non-segmented film. A "capillary" or "capillary template" refers to a structure containing a plurality of high-aspect-ratio openings or pores configured to draw and contain material via capillary action. The term "needle-like" refers to the high-aspect-ratio geometry of the scintillation material once disposed and solidified within said pores. In certain embodiments, the structured scintillator employs a waveguide architecture to facilitate oriented light propagation while suppressing lateral light crosstalk. This architecture enables the realization of high spatial resolution in X-ray imaging, even when using relatively thick scintillation layers.

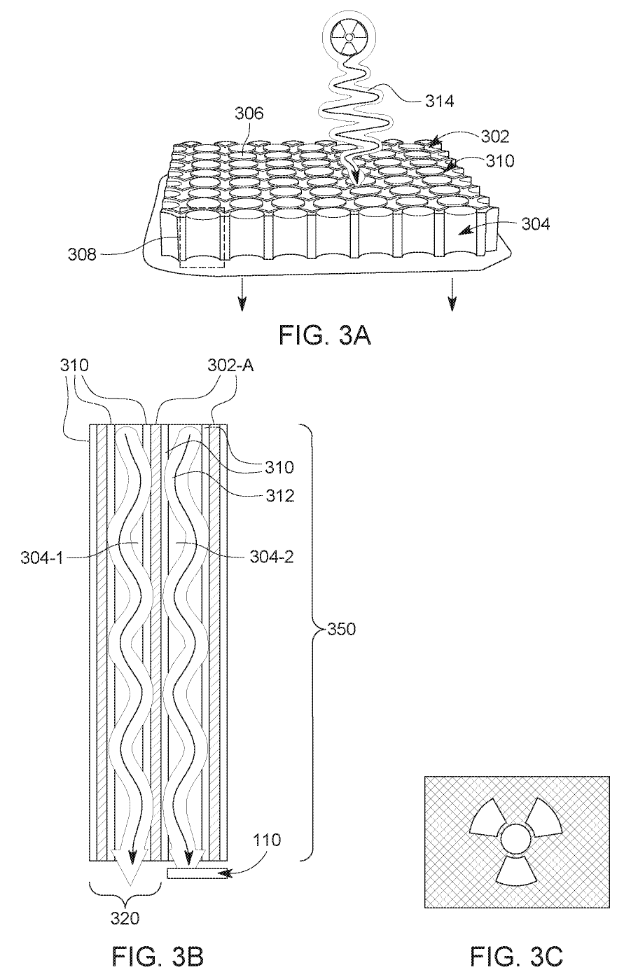

More specifically, in some embodiments, as illustrated in FIGS. 3A to 3C, a structured scintillator 300 includes a capillary array template 302, such as an aluminum-clad capillary glass array. The capillary array template 302 defines a plurality of pores or channels 304, each having a specified diameter, such as about 10 μm. These pores 304 are filled with a metal halide scintillation material 306 to form a plurality of isolated waveguide channels 320, as schematically illustrated in FIG. 3B. In one or more embodiments, the metal halide scintillation material 306 includes an OMH such as BTP₂MnBr₄. In this configuration, each isolated waveguide channel 320 defines a longitudinal axis X that is substantially perpendicular to the imaging plane of the photodetector 110, such that scintillation photons are guided predominantly along this axis toward the photodetector, consistent with the oriented light propagation illustrated in FIG. 3B.

One or more embodiments utilize a waveguide structure engineering approach where each individual pixel or "needle" 308 of the scintillator 300 is isolated from the others. Note that a pixel 308 is considered to include inner walls 302A (belonging to the capillary glass array), an aluminum layer 310, and the metal halide scintillation material 306. For instance, as illustrated in FIG. 3B in more detail, the aluminum layer (i.e., a reflective cladding) 310 is disposed within the inner walls 302A of the plurality of pores 304. In one embodiment, one or more inner walls 302A are shared by two or more adjacent pores 304-1 and 304-2. This reflective cladding 310 acts as a waveguide, confining scintillation photons 312 generated by X-ray interaction with X-rays 314 within their respective individual pixels 308. By confining the photons 312, the reflective cladding 310 minimizes unwanted lateral leakage and stack scattering, which are common causes of image blurring in non-structured or non-pixelated scintillators. FIG. 3C illustrates the propagation of scintillation photons being oriented along the vertical axis of the pixel, minimizing lateral crosstalk. This figure also shows the high clarity of the image.

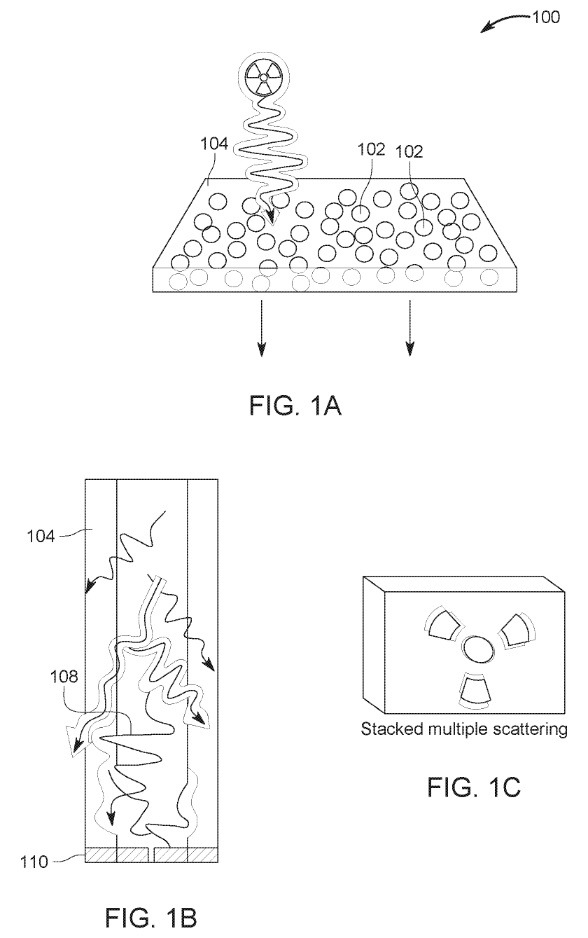

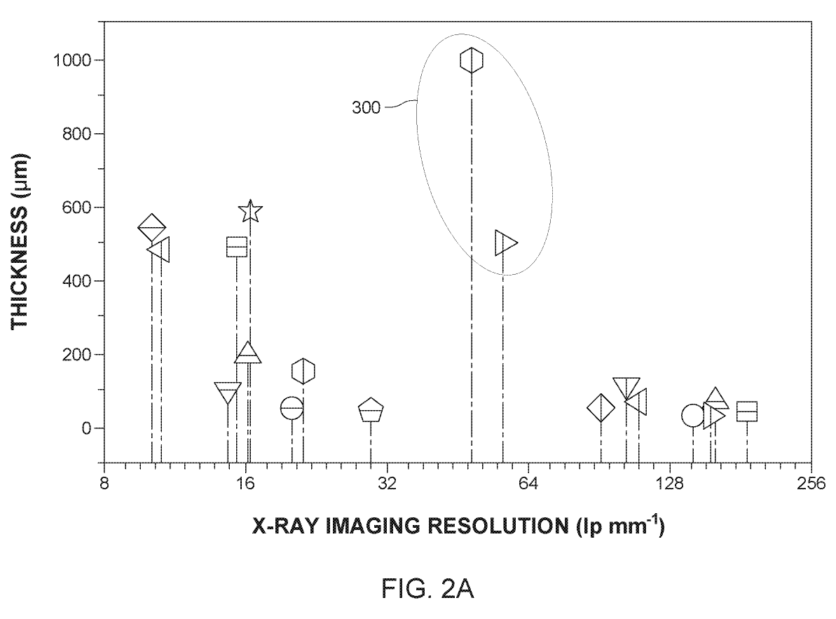

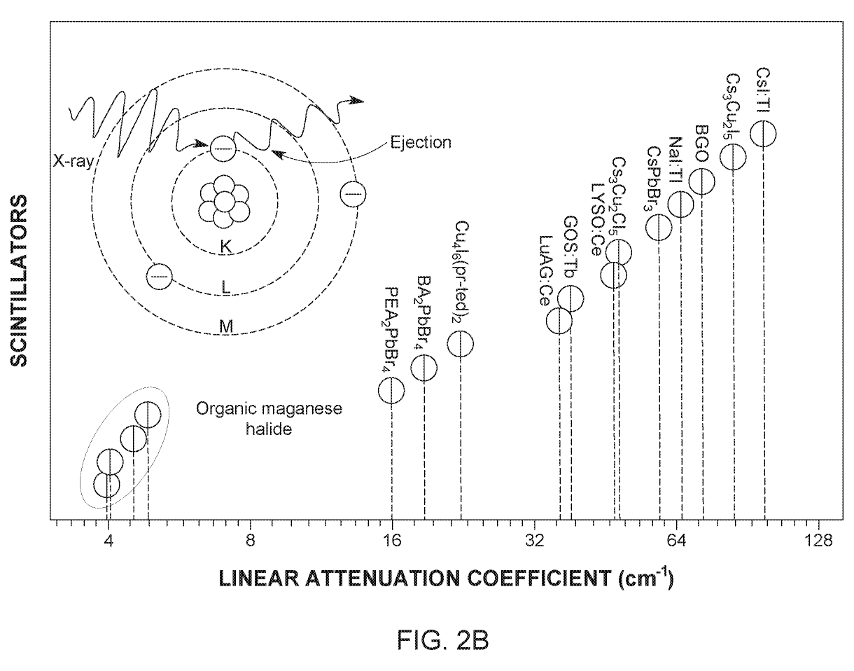

The light propagation mechanisms and results of conventional nonstructured scintillators 100 were illustrated in FIGS. 1B and 1C and those of the structured scintillators 300 were illustrated in FIGS. 3B and 3C. As the conventional scintillators 100 typically include non-oriented emitters, grain boundaries or refractive index mismatches between the emitter and matrix result in anisotropic propagation of the generated scintillation photons. Upon reaching the imaging plane of the photodetector 110, some off-track photons can cause unwanted signal crosstalk as well as low SNR in an image sensor. Since the ultimate image of a thick scintillator is a stack of multiple inhomogeneous scattering events, when the deviation induced by light scattering is larger than an imaged line width, the resultant line becomes blurred and indistinguishable.

In contrast, the structured scintillators 300 include pixelated needle-like scintillators, which are grown in an aluminum-clad capillary glass array. Although metallic aluminum oxidizes in air to form a dense layer of aluminum oxide, this is generally thin and has high transmittance, such as more than 90%, in the visible region. Thus, the vast majority of photons will pass through the thin layer of aluminum oxide on a surface and reach the metallic aluminum layer for reflection. Aluminum reflective cladding 310 within pore walls can provide over 90% reflectivity in the visible light range, confining the scintillation photons to a single pixel. Consequently, the scintillation photons oriented propagate along the needle-like scintillator and arrive at the imaging plane of the photodetector 110 through this waveguide structure. This isolated lateral light crosstalk facilitates high imaging resolution.

The scintillator 300 is typically used in a scintillator system. A scintillator system is a radiation detection setup designed to convert high-energy ionizing radiation—such as X-rays, gamma rays, or particles—into measurable electrical signals. At its core, a scintillator system 350 relies on the scintillator material 300 that "luminesces" or flashes with light when struck by radiation. Because these light pulses are typically very faint, a photodetector 110—most commonly a photomultiplier tube (PMT) or a silicon photomultiplier (SiPM)—is optically coupled to the scintillator 300. The photodetector 110’s role is to capture those photons and, through the photoelectric effect, convert them into an electrical pulse that can be digitized and analyzed by a processor having a dedicated memory (not shown).

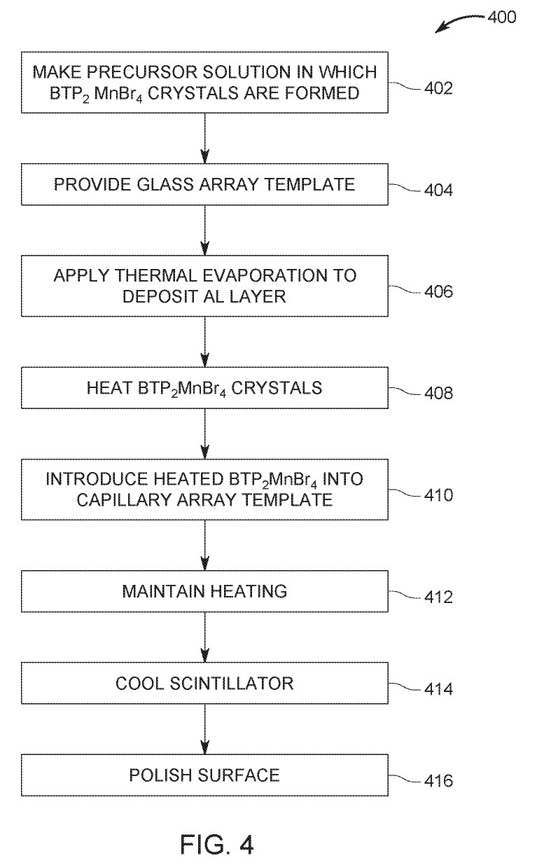

A method 400 for fabricating the metal halide scintillation material 306 and the entire scintillator 300 is illustrated in FIG. 4. The fabrication of the metal halide scintillation material 306 includes a solution-based synthesis to produce light green rodlike BTP₂MnBr₄ crystals. In one embodiment, benzyltriphenylphosphonium bromide (BTP: C₂₅H₂₂BrP) and manganese bromide (MnBr₂) are dissolved in step 402 in dichloromethane at a molar ratio of 2:1 while stirring at approximately 50 °C to form a clear precursor solution. An anti-solvent, such as ethyl acetate, is added to the precursor solution under vigorous stirring until the solution becomes cloudy, indicating saturation. Stirring is continued until the solution reclarifies, and the BTP₂MnBr₄ crystals are harvested through slow evaporation of the solution.

The synthesis of the capillary manganese halide needle-like array scintillator 300 is performed by integrating the low-temperature melting of the metal halide scintillation material 306 with the capillary array template 302. In an example process, the capillary array template 302, such as a glass array template, is provided in step 404 and placed on a substrate for the deposition of the reflective cladding 310. Thermal evaporation is utilized to deposit in step 406 an aluminum layer 310, where aluminum vapor passes through the plurality of pores 304 to ensure the inner walls are well-covered. The as-prepared BTP₂MnBr₄ crystals are heated in step 408 in a vessel until they undergo a transition into an amorphous flowing melt state at approximately 200 °C. These flowing melts are then introduced in step 410, such as by pouring, onto the preheated capillary array template 302. Continuous heating at approximately 200 °C is maintained at step 412 for a duration (e.g., 1 minute to 2 hours) sufficient to ensure the melt adequately flows into and fills the plurality of pores 304 of the capillary glass array before the temperature is slowly reduced, or cooled in step 414, to reach room temperature. Following cooling in step 414, the surface of the filled template 302 is polished in step 416 to remove any residual melt adhering to the surface, resulting in the pixelated needle-like array 300. This fabrication method is convenient, reproducible, and provides high phase purity as confirmed by powder X-ray diffraction patterns matching simulated crystal data.

In view of the technical challenges associated with X-ray absorption and light management, various evaluations were performed to characterize the performance of the structured scintillator 300. These results demonstrate how the novel waveguide architecture of the scintillator 300 addresses the traditional limitations of metal halide materials.

The classical Rayleigh criterion was used to further elucidate a resolution limit of the structured scintillator 300. This criterion indicates that two point sources are just resolved if the diffraction maximum of one source coincides with the diffraction minimum of the other. Extending it to the X-ray imaging case, assume that an X-ray-induced scintillator creates two discrete photons at proximate spatial locations, which correspond to two individual Airy disks upon the imaging plane of the photodetector 110. In this paradigm, if Δx is defined as a center-to-center separation between two Airy disks, the resolution limit is given by Δx = 1.22fλ/D, where f is a focal length of the optical system, λ is a wavelength of the photon, and D is an aperture diameter of an imaging lens.

For the unstructured scintillators (i.e., the conventional scintillators 100), unoriented linear propagation deviations due to photon scattering lead to a large overlap between the two Airy disks, making them indistinguishable, whereas, for a structured scintillator 300, photon scattering is strictly confined to a single pixel. On a macroscopic scale, this can be regarded as the linear propagation of photons within a single-pixel aperture. This means that two Airy disks can theoretically be distinguished as long as a pitch between centers of adjacent pixels exceeds the Δx value, excluding the impact of a focal spot of an X-ray source and imaging system. In other words, the effective resolution of such a structured scintillator should be limited only by the pixel size, conveying that its resolution is expected to at least equal or surpass the specified pixel size within this conceptual framework.

In one embodiment, the BTP₂MnBr₄ was chosen as the metal halide scintillation material 306 to be loaded into the capillary arrays 302 for the following reasons. The large BTP⁺ cation provides a long Mn–Mn spacing in BTP₂MnBr₄, which suppresses luminescence quenching caused by nonradiative resonance energy transfer that occurs between adjacent Mn ions, thus resulting in excellent optical and scintillation properties. Various manufactured samples exhibited intense and uniform green luminescence under both UV and X-ray excitation. The uniform distribution of needle-like scintillators results in oriented light propagation, enabling a background symbol to be clearly seen without any blurring or distortion. The powder X-ray diffraction patterns of as-prepared crystals and annealed manganese halide needle-like array scintillator were in agreement with simulated data, confirming high phase purity of the samples. Upon melting, the crystal was converted into an amorphous glassy state, which is also consistent with similar reports.

To facilitate the description of the various experiments in this document, capillary manganese halide needle-like array scintillators 300 of different thicknesses were abbreviated as Mx, where x denotes the thickness in mm of the sample. Scanning electron microscopy (SEM) combined with energy dispersive X-ray (EDX) spectroscopy revealed that the capillary manganese halide needle-like array was highly aligned with uniform elemental distribution, excluding inhomogeneities caused by cross-sectional cutting during the measurement process. Additionally, needle-like manganese halide arrays show high continuity and fill rate with few cavities or dead zones.

Top view and cross-sectional EDX mappings (not shown) show well-defined complementary distributions of corresponding elements in the needle-like manganese halide (C, P, Mn, and Br) and the capillary glass array template (mainly composed of silicon dioxide). PL excitation and PL emission spectra (not shown) illustrate very weak self-absorption of this manganese halide, which facilitates efficient light propagation across long distances in waveguide structures. A PL mapping image (not shown) of the capillary manganese halide needle-like array further verifies a uniformity of its luminescence distribution. Since samples fabricated by this synthesis pathway exhibit high homogeneity, dimensions of the scintillator can be readily and accurately controlled by manipulating the size of the capillary array template 302.

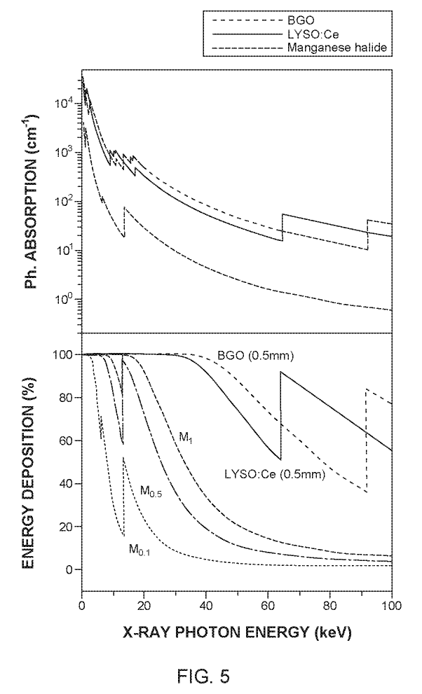

Scintillation performances of these capillary manganese halide needle-like arrays were evaluated. FIG. 5 (top) exhibits a photoelectric absorption coefficient as a function of X-ray energy for OMH and two typical commercial scintillators: bismuth germanate (BGO) and cerium-doped lutetium-yttrium oxyorthosilicate (LYSO:Ce). As mentioned previously, the organic–inorganic hybrid framework leads to relatively low photoelectric absorption coefficients for OMH compared to inorganic BGO and LYSO:Ce scintillators. For example, OMH may exhibit a linear attenuation coefficient of approximately 8 cm⁻¹ at an X-ray energy of 40 keV. This characteristic is attributed to the fact that the photoelectric effect occurs primarily at the K-shell electrons; in OMH, the K-edge originates from relatively low-atomic number components, causing absorption power to drop at higher energies. Fortunately, increasing thickness while maintaining oriented light propagation can compensate for the lack of X-ray absorption in OMH, as shown in FIG. 5 (bottom).

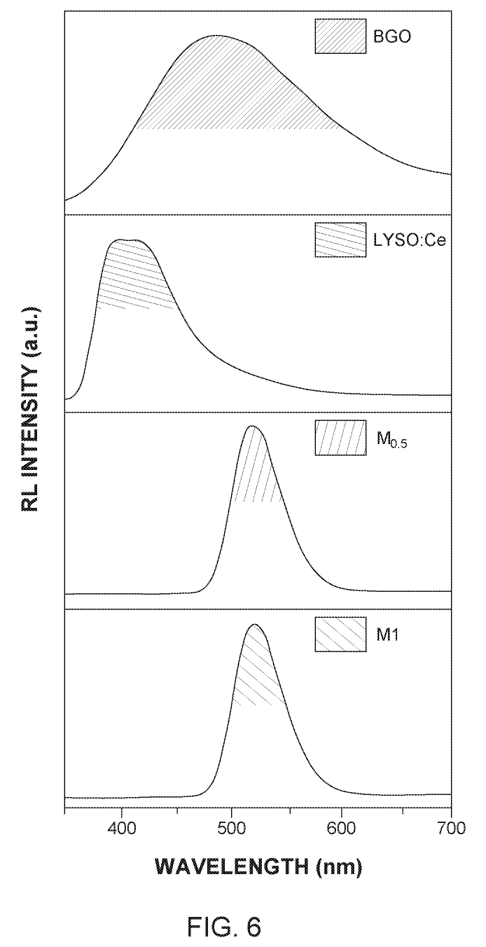

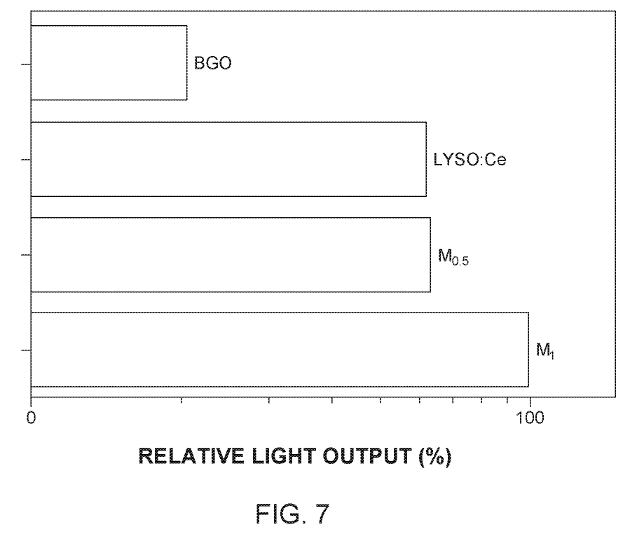

X-ray-induced RL spectra were measured in transmission mode to compare the relative light output of capillary manganese halide needle-like array scintillators 300 with BGO and LYSO:Ce scintillator references, as illustrated in FIG. 6. By integrating their X-ray-induced RL spectra and comparing results, the relative RL light outputs of BGO (0.5 mm), LYSO:Ce (0.5 mm), M0.5, and M1 are 20.8%, 62.4%, 63.9%, and 100%, respectively, as illustrated in FIG. 7. These results indicate that although OMH possesses a relatively low-atomic number (low-Z) composition, its high X-ray to visible light conversion efficiency enables it to yield high light output compared to BGO and LYSO:Ce scintillator references.

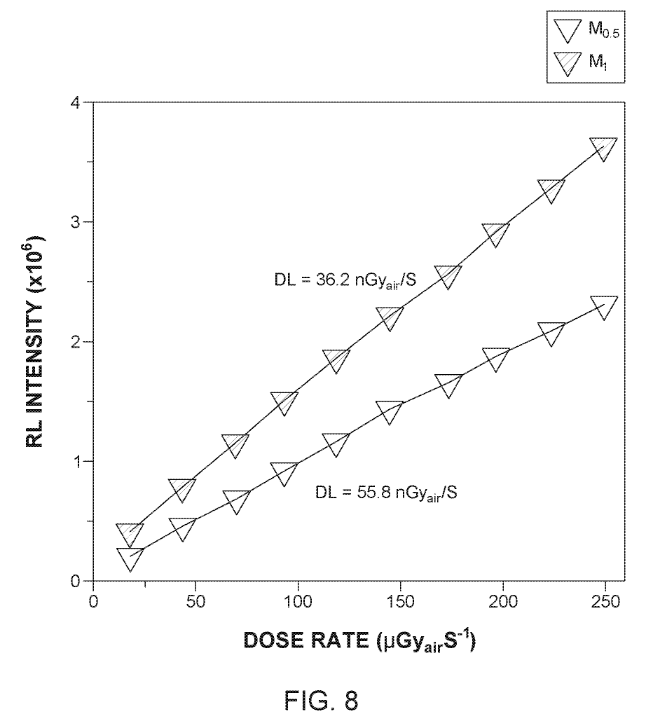

Further, due to negligible self-absorption of the OMH and effective oriented light propagation provided by the waveguide-type structure, the light output of the M1 sample with increased X-ray energy deposition presents a considerable enhancement compared to the M0.5 sample. Both M1 and M0.5 samples displayed a nearly linear response over a range of dose rates from 7.8 to 250 μGyair s⁻¹ (see FIG. 8). Detection limits for M1 and M0.5 were derived from dose rate-dependent fitted RL curves as 36.2 and 55.8 nGyair s⁻¹, respectively, which were approximately two orders of magnitude lower than a dose rate required for typical medical X-ray diagnoses (5.5 μGyair s⁻¹).

In addition, an RL signal response of a capillary manganese halide array scintillator demonstrates no obvious degradation when subjected to total X-ray irradiation for ≈25 h (with a cumulative dose of ≈23 Gyair), implying a capacity to maintain reliable and sustained scintillation performance under prolonged radiation exposure.

These results indicate that capillary manganese halide needle-like array scintillators 300 with excellent scintillation properties are promising candidates for high-resolution flat-panel X-ray imaging.

To verify light confinement of the designed capillary manganese halide needle-like array scintillators 300, dedicated optical paths (not shown) were built to record an evolution of a laser beam spot profile in an optical field distribution before and after passing through different samples. Specifically, a femtosecond-pulsed infrared (IR) laser beam (λ: 1030 nm, repetition rate: 2.0 MHz) was directed to a 40/60 beam splitter, and 40% of it was used for second harmonic generation to produce 515 nm green light. Neutral-density (ND) filters with ND values of 1 and 2, along with a variable ND filter, were employed to control laser intensity and prevent sample damage. The beam was reflected by mirrors 2 and 3, and focused on the sample using a lens 1 with F = 100 mm. Subsequently, lens 2 and lens 3 re-focused the beam after interacting with the sample, directing it toward an optical beam profiler designed for wavelengths ranging from 200 to 1100 nm. All measurements, including blank experiments, were conducted using an identical setup, ensuring consistent distances between samples and the optical beam profiler.

The inventors found that a background without the laser beam and a profile of an incident primary laser spot were first recorded by the optical beam profiler, respectively. Due to a light confinement effect of the aluminum reflective cladding layer 310 inside a capillary wall 302A, the original laser spot shows weak expansion values of about 1.42 and 1.68 times after passing through the M0.5 and M1 with aluminum-cladding samples, respectively. This expansion was attributed to light scattering within the pore of the capillary array. Extension of the M1 sample is slightly larger than that of M0.5, which may be related to increased light scattering during longer distance propagation in the pore.

As references, a profile of the laser spot becomes blurred and hard to distinguish when passing through an M0.5 without an aluminum-cladding sample and pristine manganese halide powder polydimethylsilox-ane (PDMS) film due to severe optical crosstalk. Furthermore, laser diffraction patterns after passing through various samples were captured (not shown) by a camera. It is noteworthy that the distance between different samples and a projection screen is fixed. A capillary manganese halide needle-like array with aluminum-cladding samples displays small, intense, and well-defined diffraction fringes, while a sample without aluminum cladding exhibits decreased intensity and a widened scattering range (not shown). These results provide evidence that the designed aluminum-cladding capillary manganese halide needle-like array 300 can successfully isolate light crosstalk through light confinement effects.

Motivated by the scintillation performance and light confinement effects of this capillary manganese halide needle-like array scintillator 300, X-ray imaging applications were further investigated. In an experimental setup, a laboratory portable X-ray tube was used as an imaging source. Since it is different from a highly collimated synchrotron radiation beam used in micro-X-ray imaging, an effect of a focal spot of the X-ray source was taken into account. Given its known cone angle of 86°, the X-ray source was placed far enough away from the sample to act as a quasiparallel light source.

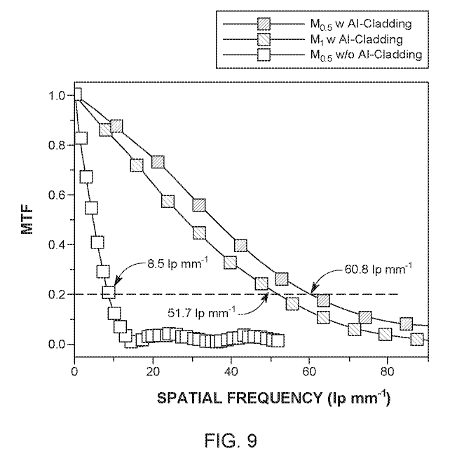

The inventors found that the capillary manganese halide needle-like array scintillator 300 exhibits a strong green RL emission under X-ray excitation. Gray value mapping extracted from a region of interest confirms that RL emission shows a homogeneous distribution (not shown). Uniform luminescence is a prerequisite for achieving high-resolution X-ray imaging. The MTF curves of aluminum clads M0.5 and M1 were first calculated by extracting X-ray images for sharp edges of a tungsten sheet, as shown in FIG. 9. As expected, ultrahigh spatial resolutions of 60.8 and 51.7 lp mm⁻¹ at an MTF value of 0.2 were achieved for aluminum-clad M0.5 and M1 scintillators, respectively. Their resolution all exceeds a pore diameter (10 μm) of the capillary template, which implies that lateral photon leakage was isolated. Variation in resolution may be related to light scattering caused by different light propagation distances in the hole, which also corresponds to phenomena of light confinement experiments.

As a comparison, X-ray imaging of different samples was measured using a standard resolution card, further supporting the resolution of the aluminum-clad capillary manganese halide needle-like array scintillator. Moreover, X-ray images of capillary manganese halide scintillators with and without aluminum-cladding samples as well as transparent LYSO:Ce scintillator were recorded under normal exposure and overexposure (not shown). An aluminum-cladding sample displays sharp edges under overexposure, while an aluminum-free-cladding sample and LYSO:Ce scintillators show blurred edges because of light scattering. These further emphasize a contribution of waveguide structure engineering in isolation of light crosstalk.

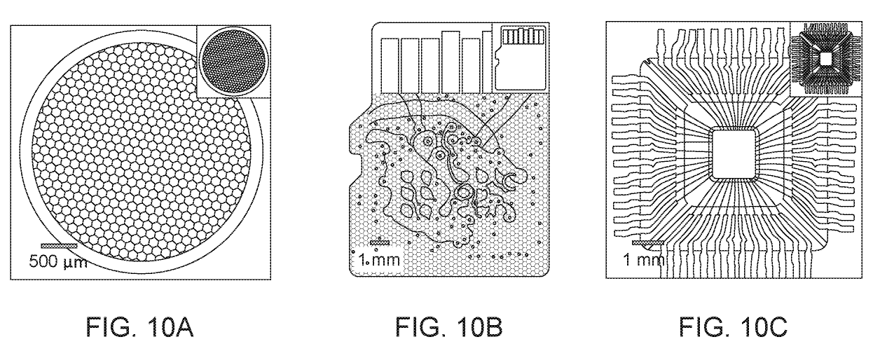

To visualize and check resolution limits, a microresolution chart (JIMA RT RC-05B, 3–50 μm) was used for imaging. The inventors found that a spatial resolution of up to 8 μm (i.e., 62.5 lp mm⁻¹) can be resolved in a microresolution chart from gray value intensity along lines for an aluminum-clad M0.5 scintillator. Observable resolution of an aluminum-clad M1 sample drops to 9–10 μm (i.e., 50–55.5 lp mm⁻¹), but still exceeds its own pore diameter (not shown). FIGS. 10A to 10C show bright-field and X-ray images of a copper grid, a storage card, and a chip, respectively. Structural details can be defined for tiny bonding wires and bonding points in a circuit. These prototype experiments for nondestructive testing of electronic devices demonstrate that this capillary manganese halide needle-like array scintillator holds potential as an alternative to current commercial counterparts.

Thus, a capillary manganese halide needle-like array scintillator 300 with isolated light crosstalk was developed via a synthesis approach. A feature of this structure is its capability of oriented light propagation, enabling ultrahigh resolutions of 60.8 and 51.7 lp mm⁻¹ at an MTF of 0.2 for 0.5 mm and 1 mm thick scintillators, respectively. This resolution stands as one of the highest for X-ray imaging, particularly among metal halide scintillators.

Furthermore, given that both resolutions exceed a pore diameter of the capillary arrays template (Φ = 10 μm), which, along with laser diffraction experiments results, serves as direct evidence for light confinement effects achieved through waveguide structure engineering. As a result, a combination of high light output, low detection limit, eco-friendly element composition, high resolution, and cost-effectiveness makes this thick scintillator 300 promising for X-ray imaging-related applications spanning scientific research to real-life fields. These findings offer insights into harmonization of scintillator-thickness-dependent X-ray imaging spatial resolution and scintillation brightness, presenting a strategy for developing high-performance X-ray imaging scintillators.

A description for one of the above figures may apply to another of the above figures. Examples, embodiments, and methods described above may be combined if there is no conflict. An event or block described above may be optional or omitted. For example, an event or block with dashed lines in the figures may be optional.

The structured scintillator described in the various embodiments may be integrated into various X-ray imaging systems, such as digital radiography detectors or micro-computed tomography (micro-CT) scanners. The high spatial resolution provided by the isolated waveguide channels allows for the non-destructive testing of microelectronic components and high-precision medical diagnostics. While certain materials and dimensions have been described, such as BTP₂MnBr₄ and 10 μm pore diameters, these are provided as examples and are not intended to limit the scope of the waveguide engineering principles disclosed herein.

Upon reading this document, those of skill in the art will appreciate still additional and alternative structural and functional designs for high-resolution X-ray imaging through the principles disclosed herein. Thus, while particular examples and applications have been illustrated and described, it is to be understood that the disclosed examples are not limited to the precise construction and components disclosed herein. Various modifications, changes, and variations, which will be apparent to those of ordinary skill in the art, may be made in the arrangement, operation, and details of the method and apparatus disclosed herein without departing from the spirit and scope defined in the appended claims.

Numerical adjectives “first”, “second”, and “third” do not imply any order (are not ordinals) but are markers to distinguish separate instances of similar elements. References to the singular (e.g., “a” or “an”, “the”) should include the plural unless clearly indicated otherwise.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

Although the features and elements of the present embodiments are described in the embodiments in particular combinations, each feature or element can be used alone without the other features and elements of the embodiments or in various combinations with or without other features and elements disclosed herein.

The terms “about” and “substantially” and “approximately” when used in this application mean a variation of up to 20% of the parameter characterized by these terms.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The entire content of all the publications listed herein is incorporated by reference in this patent application.

1 S. Liu, M. Gu, H. Chen, Z. Sun, X. Liu, B. Liu, S. Huang, J. Zhang, Nucl. Instrum. Methods Phys. Res., Sect. A 2018, 903, 18.

2 Y. Hormozan, I. Sychugov, J. Linnros, Med. Phys. 2016, 43, 696.

3 V. V. Nagarkar, B. Singh, I. Shestakova, V. Gaysinskiy, IEEE Nucl. Sci. Symp. Conf. Rec. 2005, 4, 2179.

4 W. Shao, G. Zhu, X. Wang, Z. Zhang, H. Lv, W. Deng, X. Zhang, H. Liang, ACS Appl. Mater. Interfaces 2023, 15, 932.

5 K. Han, K. Sakhatskyi, J. Jin, Q. Zhang, M. V. Kovalenko, Z. Xia, Adv. Mater. 2022, 34, 2110420.

6 L. Xu, X. Lin, Q. He, M. Worku, B. Ma, Nat. Commun. 2020, 11, 4329.

7 M. P. Davydova, L. Meng, M. I. Rakhmanova, Z. Jia, A. S. Berezin, I. Y. Bagryanskaya, Q. Lin, H. Meng, A. V. Artem’ev, Adv. Mater. 2023, 35, 2303611.

8 Y. Xu, Z. Li, G. Peng, F. Qiu, Z. Li, Y. Lei, Y. Deng, H. Wang, Z. Liu, Z. Jin, Adv. Opt. Mater. 2023, 11, 13.

9 B. Li, Y. Xu, X. Zhang, K. Han, J. Jin, Z. Xia, Adv. Opt. Mater. 2022, 10, 2102793.

H. Li, H. Yang, R. Yuan, Z. Sun, Y. Yang, J. Zhao, Q. Li, Z. Zhang, Adv. Opt. Mater. 2021, 9, 2101297.

Z. Zhang, H. Dierks, N. Lamers, C. Sun, K. Nováková, C. Hetherington, I. G. Scheblykin, J. Wallentin, ACS Appl. Nano Mater. 2022, 5, 881.

H. Dierks, Z. Zhang, N. Lamers, J. Wallentin, Nano Res. 2023, 16, 1084.

S. Liu, M. Gu, H. Chen, Z. Sun, X. Liu, B. Liu, S. Huang, J. Zhang, Nucl. Instrum. Methods Phys. Res., Sect. A 2018, 903, 18.

L. Yi, B. Hou, H. Zhao, H. Tan, X. Liu, Nat. Photonics 2023, 17, 494.

J. Hui, P. Ran, Y. Su, L. Yang, X. Xu, T. Liu, Y. M. Yang, J. Phys. Chem. C 2022, 126, 12882.

What is claimed is:

1. A structured scintillator, comprising:
a capillary array template defining a plurality of pores, each pore of the plurality of pores comprising an inner wall;
a reflective cladding disposed on the inner wall of each pore of the plurality of pores to define a plurality of isolated waveguide channels; and
a metal halide scintillation material disposed within the plurality of isolated waveguide channels,
wherein the reflective cladding is configured to confine photons generated by the metal halide scintillation material within the plurality of isolated waveguide channels to facilitate oriented light propagation toward an imaging plane.

2. The structured scintillator of claim 1, wherein the plurality of isolated waveguide channels form a pixelated needle-like array configured to direct the photons along an axis substantially perpendicular to the imaging plane.

3. The structured scintillator of claim 1, wherein the reflective cladding is configured to decouple a thickness of the metal halide scintillation material from a spatial resolution of an image produced at the imaging plane by preventing lateral light crosstalk between adjacent isolated waveguide channels.

4. The structured scintillator of claim 1, wherein the metal halide scintillation material comprises an organic manganese halide.

5. The structured scintillator of claim 4, wherein the organic manganese halide comprises benzyl triphenylphosphonium manganese bromide (BTP₂MnBr₄).

6. The structured scintillator of claim 1, wherein the reflective cladding comprises an aluminum layer.

7. The structured scintillator of claim 1, wherein each pore of the plurality of pores has a diameter of approximately 10 μm.

8. The structured scintillator of claim 1, wherein the capillary array template has a thickness between 0.5 mm and 1.0 mm.

9. The structured scintillator of claim 1, wherein the reflective cladding is configured to provide at least 90% reflectivity in a visible light range to confine the photons within a single isolated waveguide channel of the plurality of isolated waveguide channels.

10. The structured scintillator of claim 1, wherein the capillary array template comprises a glass array template, and the reflective cladding is disposed between the glass array template and the metal halide scintillation material.

11. The structured scintillator of claim 1, wherein the structured scintillator exhibits a spatial resolution at a modulation transfer function (MTF) of 0.2 that is numerically greater than a reciprocal of a diameter of the plurality of pores.

12. The structured scintillator of claim 1, wherein the metal halide scintillation material has a linear attenuation coefficient of approximately 8 cm⁻¹ at an X-ray energy of 40 keV, and wherein a thickness of the structured scintillator is selected to compensate for the linear attenuation coefficient to achieve a signal-to-noise ratio (SNR) suitable for micro-X-ray imaging.

13. The structured scintillator of claim 1, wherein the capillary array template comprises a glass array template having a lower refractive index than a refractive index of the metal halide scintillation material.

14. A method for fabricating a structured scintillator comprising:
depositing a reflective cladding on inner walls of a plurality of pores defined by a capillary array template to form a plurality of isolated waveguide channels;
heating a metal halide scintillation material to a melt state;
introducing the metal halide scintillation material in the melt state into the plurality of isolated waveguide channels; and
cooling the metal halide scintillation material to form a pixelated needle-like array within the capillary array template.

15. The method of claim 14, further comprising:
preheating the capillary array template prior to introducing the metal halide scintillation material.

16. The method of claim 14, wherein depositing the reflective cladding comprises thermally evaporating aluminum onto the capillary array template such that aluminum vapor passes through the plurality of pores to coat the inner walls.

17. The method of claim 14, wherein heating the metal halide scintillation material comprises heating benzyl triphenylphosphonium manganese bromide to a temperature of approximately 200 °C.

18. The method of claim 14, further comprising:
maintaining the capillary array template at a temperature of approximately 200 °C after introducing the metal halide scintillation material in the melt state for a given duration to ensure the melt fills the plurality of isolated waveguide channels, and subsequently reducing the temperature to room temperature.

19. The method of claim 14, further comprising:
polishing a surface of the capillary array template after cooling to remove residual scintillation material.

20. A scintillator system, comprising:
a structured scintillator configured to transform high-energy ionizing energy into light; and
a photodetector configured to receive the light and generate an electrical signal indicative of the amount of ligh,
wherein the structured scintillator comprises:
a capillary array template defining a plurality of pores, each pore of the plurality of pores comprising an inner wall,
a reflective cladding disposed on the inner wall of each pore of the plurality of pores to define a plurality of isolated waveguide channels, and
a metal halide scintillation material disposed within the plurality of isolated waveguide channels,
wherein the reflective cladding is configured to confine photons generated by the metal halide scintillation material within the plurality of isolated waveguide channels to facilitate oriented light propagation toward an imaging plane.
